(19) United States
(12) Patent Application Publication
(10) Pub. No.: US 2009/0171835 A1
(43) Pub. Date: Jul. 2, 2009

(54) Multiple Payment Transaction Systems

(75) Inventor: Simon Blythe, Cambridgeshire (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/964,149

(22) Filed: Dec. 26, 2007

(51) Int. Cl. G06Q 20/00

(52) U.S. Cl. 705/39

(57) ABSTRACT

A system and method of conducting multiple payment transactions is disclosed. The system and method allow a consumer to make contributions to selected groups based upon the consumer's financial activity. The invention could be used by a consumer to identify beneficiaries and can be used by merchants and payment network providers to provide donations.

### BACKGROUND OF THE INVENTION

1. Field of the Invention

The invention relates to a method and system of conducting multiple payment transactions, and more particularly to conducting multiple transactions across various financial accounts.

2. Brief Description of the Related Art

Many affiliation groups partner up with a credit card issuer to sponsor credit card accounts offered by the credit card issuers. These credit card issuers believe a credit card holder who is a member of an affiliation group is more likely to use his account if it benefits the affiliation group sponsor. The affiliation group sponsor typically receives a benefit from a credit card issuer, such as a finder's fee for acquiring each new member account. Examples of affiliation group sponsors include alumni associations, religious organizations, sports teams, and professional associations.

In addition, many types of affiliation groups make discounts and benefits available exclusively to their members. Often, these discounts and benefits are not provided directly through the membership organization, but are instead obtained through third-party suppliers of goods or services. These types of arrangements serve a dual purpose in that they allow an affiliation group to provide additional benefits to its members, while simultaneously encouraging such members to patronize a particular third-party provider of goods or services.

Meanwhile, various affiliation groups solicit contributions from their members for various goals. Typically, this is done through mailings, phone solicitations, and e-mails. While these techniques are effective in reaching the goals of the affiliation group, there is an increased need in the art to automate and process contributions more efficiently.

Accordingly, there exists a need for enabling affiliation group members to accrue benefits or contributions through payment transactions and to donate the benefits or contributions to third-party entities, groups, organizations, and charities. Such an arrangement could also allow affiliation group members to select third-party entities, groups, organizations, and charities that share or could reinforce the affiliation group's beliefs, principles, or goals.

### SUMMARY OF THE INVENTION

A system and method of conducting multiple payment transactions is disclosed. The system and method allow a consumer to make contributions to selected groups based upon the consumer's financial activity. The invention could be used by a consumer to identify beneficiaries and can be used by merchants and payment network providers to provide donations.

In one aspect of the invention, a system for conducting multiple payment transactions is provided. The system includes a payment device capable of transmitting a financial transaction instruction for charging a consumer account a first monetary amount and a second monetary amount. The first monetary amount is hereinafter referred to as a request amount. The second monetary amount is hereinafter referred to as a donation amount. The system further provides a processing module for charging the request amount to the consumer account and crediting the donation amount to a beneficiary account.

In a preferred embodiment, the financial transaction instruction includes a first description of a first good or service. The first description is hereinafter referred to as a purchasing description of a good or service being purchased.

In another preferred embodiment, the processing module provides a graphical user interface to select at least one of a beneficiary account, a donation amount, and a second description of a good or service. The second description of a good or service is hereinafter referred to as a pre-selected description of a good or service.

In yet another preferred embodiment, the processing module associates a selected beneficiary account, a donation amount, and a pre-selected description with the consumer account.

In a further embodiment, the processing module compares a purchasing description to a pre-selected description that is associated to at least one of a consumer account, a payment network account, or a merchant account. Based on the comparison, the processing module further credits the donation amount to the beneficiary account.

In yet a further embodiment, the processing module charges the donation amount to a merchant account.

In another embodiment, the processing module charges a fee for processing the financial transaction instruction and credits a portion of that fee to a beneficiary account.

In yet another embodiment, the payment device is selected from the group consisting essentially of a smart card, magnetic strip card, PDA, and cellular phone.

In another aspect of the invention, a method for conducting multiple payment transactions is provided. The method includes transmitting a financial transaction instruction for charging a consumer account a request amount and a donation amount. The method further includes charging the request amount to the consumer account and crediting the donation amount to a beneficiary account.

In a preferred embodiment, the financial transaction instruction includes a purchasing description of a good or service being purchased.

In another preferred embodiment, the method further includes providing a graphical user interface to select at least one of a beneficiary account, a donation amount, and a pre-selected description of a good or service.

In yet another preferred embodiment, the method includes associating a selected beneficiary account, a donation amount, and a pre-selected description with the consumer account.

In a further embodiment, the method includes comparing a purchasing description to a pre-selected description that is associated to at least one of a consumer account, payment network account, or a merchant account. Based on the comparison, the processing module further credits the donation amount to the beneficiary account.

In yet a further embodiment, the method includes charging the donation amount to a merchant account.

In another embodiment, the method includes charging a fee for processing the financial transaction instruction and credits a portion of that fee to a beneficiary account.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a multiple payment system according to the present invention.

FIG. 2 illustrates an example graphical user interface for specifying a beneficiary account in accordance with the present invention.

FIG. 3 is a flow chart of a method for conducting multiple payment transaction according to the present invention.

Like reference symbols in the various drawings indicate like elements.

### DETAILED DESCRIPTION OF THE PREFERRED EMBODIMENTS

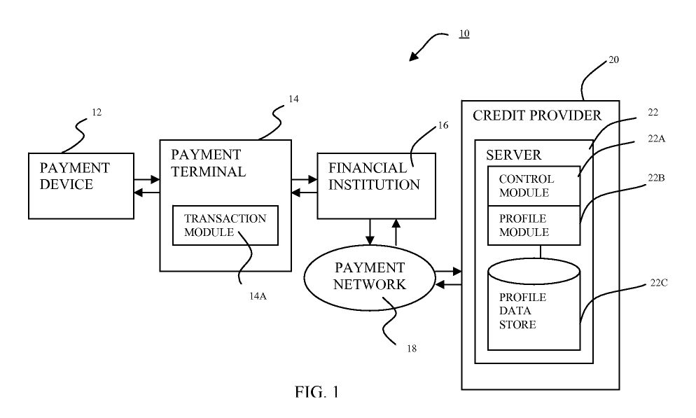

FIG. 1 provides an illustrative representation of a multiple payment transaction system 10 according to the present invention. The system 10 allows a consumer to charge a first monetary amount to a consumer account and to provide a second monetary amount to a beneficiary account.

As used herein, the term “first monetary amount” refers to a monetary amount that the consumer account is requested to be charged for a good or service that the consumer has purchased from a vendor. The term “first monetary amount” is hereinafter referred to as a request amount.

As used herein, the term “second monetary amount” refers to a monetary amount that can be charged to at least one of a consumer account, payment network account, or merchant account, and credited to a beneficiary account. The term “second monetary amount” is hereinafter referred to as a donation amount. In one preferred embodiment, the donation amount is a percentage or a defined amount of the request amount. In another preferred embodiment, the donation amount is a portion of a transaction fee that is typically charged by a financial institution for conducting a financial transaction. In yet another preferred embodiment, the donation amount is a percentage or a defined amount determined by the consumer, payment network, or merchant.

As shown in FIG. 1, in one preferred embodiment, the system 10 includes a payment device 12 capable of receiving and sending transaction information relating to specified classes of goods or services and a payment terminal 14 that may operate as a point of sale (POS) terminal for merchants.

The payment device 12 shown in FIG. 1 can be any type of personal computer device, including but not limited to a personal computer, such as a laptop computer, handheld computer, mobile phone and, personal digital assistant (PDA), and/or any other device comprising electronic and/or magnetic components, such as a smart card and magnetic stripe card. Although only one payment device is shown in FIG. 1, the present invention is not limited to one payment device and can include a multitude of varied payment devices that are capable of communicating using various secure protocols.

The payment terminal 14 of the present invention is a computer device that operates as a point of sale terminal for goods or services rendered. As shown in FIG. 1, in one preferred embodiment, the payment terminal 14 includes a transaction module 14A for processing a transaction instruction, processing a donation option, and displaying an authorization message.

As shown in FIG. 1, in one preferred embodiment, the payment terminal 14 is in communication with a financial institution 16, such as a bank, which has access to a conventional payment network 18 in which the merchant has a financial account.

A credit provider 20 is also preferably in communication with the payment network 18 and provides a particular level of credit to the payment device consumer. As shown in FIG. 1, in one preferred embodiment, the credit provider 20 includes 1) a server 22 that is configured to include a control module 22A for authorizing transactions and processing a request amount defined by payment device consumers, and 2) a profile module 22B for providing a graphical user interface and processing a donation option, and 3) a profile datastore 22C for storing data concerning at least one of a consumer account, payment network account, merchant account, and a beneficiary account.

As used herein, the term “consumer account” refers to information that identifies a name or identifier for a particular consumer. The consumer account can also include information concerning at least one of a transaction account, a total amount of allowable credit balance available, a pre-selected description of goods or services, a donation amount, and a beneficiary account. The consumer account can further include information concerning associations of the consumer to a list of groups, affiliations, organizations, special interests, goals, hobbies, social networks, or any entity to which the particular consumer is a member, has an affiliation, or has an interest in. For example, the consumer account can include information concerning the consumer's cultural, political, professional, religious, social affiliations, or any combination thereof.

As used herein, the term “beneficiary account” refers to information that identifies a name or identifier for a particular beneficiary. The beneficiary account can also include information concerning at least one of a transaction account. The beneficiary account can further include information concerning associations of the beneficiary to a list of groups, affiliations, organizations, special interests, goals, hobbies, social networks, or any entity to which the particular consumer is a member, has an affiliation, or has an interest in. For example, the beneficiary account can include information concerning the beneficiary's cultural, political, professional, religious, social affiliations, or any combination thereof.

The beneficiary can include one or more individuals, groups, or organizations. The beneficiary can include, for example, a family member, a neighbor, a friend, a political organization or candidate, a religious organization, a charity, a government, a sports team, a school, a community organization, relief funds, etc., or members thereof. Other examples of a beneficiary include publicly and privately supported educational organizations; hospitals and medical research organizations; publicly and privately supported organizations such as museums, libraries, support groups for cultural organizations, organizations for the gathering of contributions for research into and the elimination of medical disorders, organizations that provide direct services to the public, or members thereof.

As used herein, the term “payment network account” refers to information that identifies a name or identifier for a particular payment network. The payment network account can also include information concerning at least one of a transaction account, a pre-selected description of goods or services, a donation amount, and a beneficiary account. The payment network account can further include information concerning associations of the payment network to a list of groups, affiliations, organizations, special interests, social networks, or any entity to which the particular payment network is a member, or has an affiliation, or has an interest in.

As used herein, the term “merchant account” refers to information that identifies a name or identifier for a particular merchant. The merchant account can also include information concerning at least one of a transaction account, a pre-selected description of goods or services, a donation amount, and a beneficiary account. The merchant account can further include information concerning associations of the merchant to a list of groups, affiliations, organizations, special interests, goals, hobbies, social networks, or any entity to which the particular merchant is a member, has an affiliation, or has an interest in. For example, the merchant account can include information concerning the merchant's cultural, political, professional, religious, social affiliations, or any combination thereof.

As used herein, the term “pre-selected description of a good or service” refers to a description of a good or service that at least one of a consumer, payment network, or a merchant has pre-selected as being in association with at least one of a consumer account, payment network account, or a merchant account, and that is stored in the profile datastore 22C. Preferably, the pre-selected description of a good or service is compared with a purchasing description of a good or service prior to providing a donation amount to the beneficiary account.

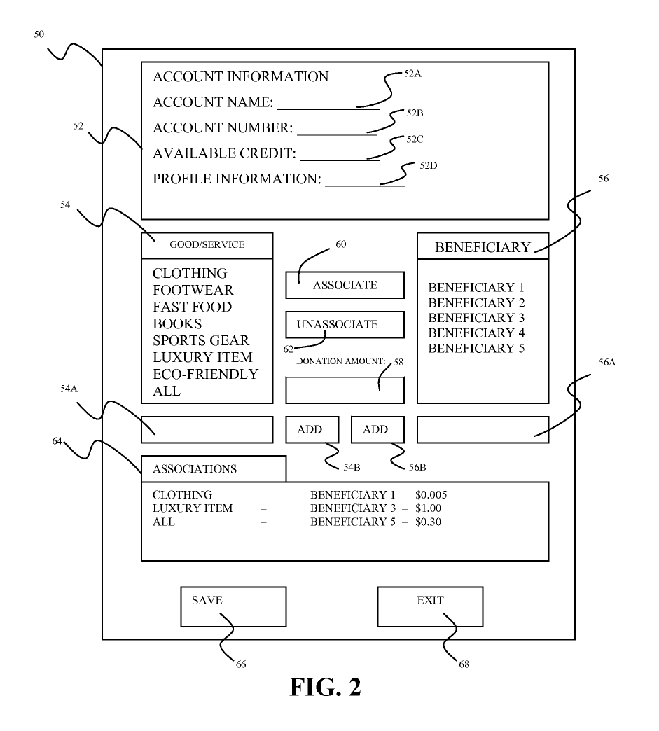

Referring now to FIG. 2, an example graphical user interface 50 provided by a profile module 22B is shown. The graphical user interface 50 allows a user of the system to specify information, such as the user account information 52, a pre-selected description of goods or services 54, a particular donation amount 58, and a beneficiary account 56.

As used herein, the term “user” refers to a consumer, payment network, or merchant that uses the graphical user interface.

In one preferred embodiment, where the profile module 22B provides the graphical user interface 50 on a PC that is in communication with the server 22, the profile module 22B receives the information specified by the user, and stores the information specified by the user to the profile datastore 22C.

As shown in FIG. 2, in one preferred embodiment, for example, the graphical user interface 50 includes an account information area 52 that displays detail account information relating to a particular user account. For example, as shown in FIG. 2, the account information area 52 can include an account name 52A, a unique account number 52B, a total amount of allowable credit 52C available for the particular account, as well as user profile information 52D, such as a list of groups, affiliations, organizations, special interests, goals, hobbies, social networks, or any entity to which the particular user is a member, has an affiliation, or has an interest in.

In one preferred embodiment, the graphical user interface 50 includes a selectable listing of descriptions of goods or services 54 and a selectable listing of beneficiary accounts 56, each of which may be associated with one another and a donation amount 58 upon selection of associate button 60, and disassociated with one another upon selection of an unassociate button 62.

As shown in FIG. 2, in one preferred embodiment, the pre-selected description of goods or services can be entered through category entry area 54A upon selection of add button 54B and then selected from the description list 54. In addition, it will be appreciated by one skilled in the art that the descriptions shown in FIG. 2 are merely exemplary, and that other descriptions of goods and services can be entered and provided by the profile module 22B for selection through the interface 50.

Similarly, a beneficiary account can be entered using a beneficiary entry area 56A upon selection of add button 56B and then be selected from the beneficiary list 56.

It will be appreciated by one skilled in the art that although a set of description and beneficiary account lists is shown in FIG. 2, the present invention is not limited to these two lists and can include any number of sets of lists. For example, in another preferred embodiment, a selectable listing of merchant accounts can be entered. The merchant account can be associated with a donation amount, pre-selected description of goods or services, and a beneficiary account.

In one preferred embodiment, the graphical user interface 50 also includes a listing of associations 64 made using the payment device 12. The listing of associations can include associations between the pre-selected description of goods or services, donation amount, consumer account information, beneficiary account information, and merchant account information, or any combination thereof.

In another preferred embodiment, the graphical user interface 50 includes suggested consumer accounts, payment network accounts, beneficiary accounts, merchant accounts, descriptions of goods or services, or a suggested combination thereof that may be of interest to the particular user. Examples of such information might include information regarding newly developed or geographically local groups, entities, or organizations that share similar affiliations or interests with the user. The list of suggestions may vary at different times, such as when a particular organization has traditional seasonal drives or as different consumers, payment networks, merchants, or beneficiaries choose to join or quit the described system.

Once a user has specified at least one of a user account information 52, a pre-selected description of goods or services 54, a particular donation amount 58, and a beneficiary account 56, upon selection of a save button 66, the profile module 22B stores the associations to the profile datastore 22C.

Upon selection of an exit button 68, the profile module 22B terminates the user interface 50.

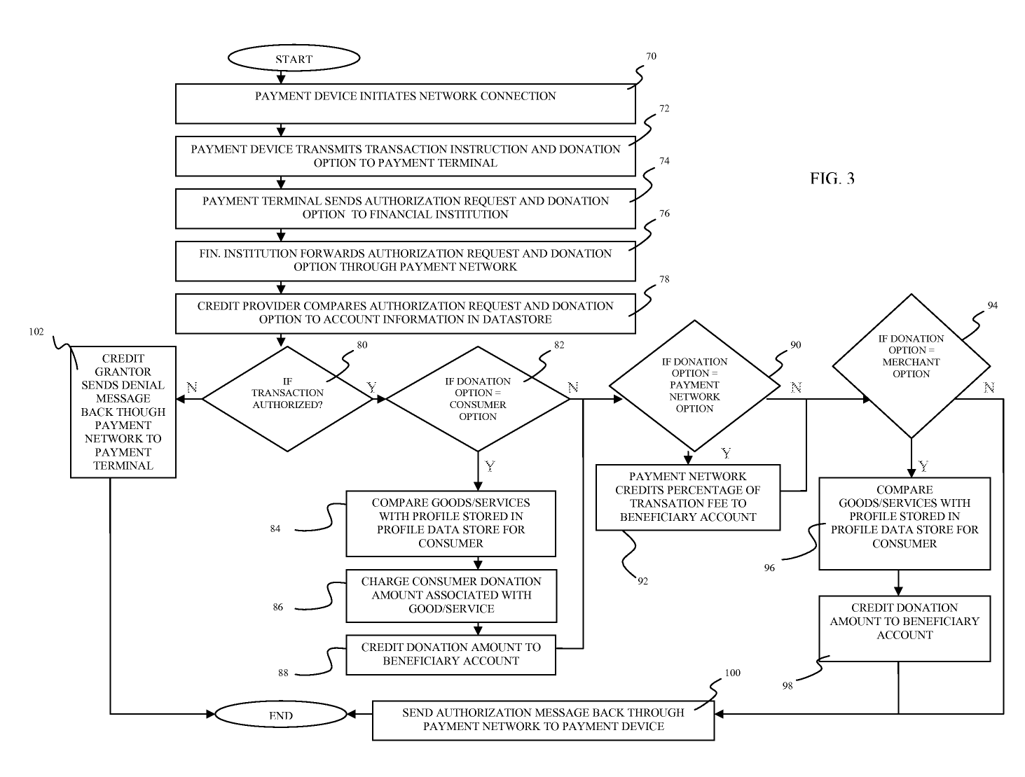

Referring now to FIGS. 1 and 3, a typical transaction executed by the system using the techniques of the present invention will now be described. As shown in the FIG. 3 example, first, the payment device 12 initiates a network connection 70 to the payment terminal 14. In one preferred embodiment, where the payment device 12 is a cellular phone, a telephone company (TELCO) provider can be used as a gateway into one or more payment networks. In another preferred embodiment, where the payment device is a smart card, the payment device 12 initiates the network connection by polling for a wireless network connection as is known in the art. Preferably, the network connection is a secure connection that includes encryption and digital authentication.

Once the payment device 12 is connected to the payment terminal 14, the payment device 12 transmits a transaction instruction and donation option 72 to the payment terminal 14.

In one preferred embodiment, the transaction instruction includes a purchasing description of a good or service. As used herein, the term “purchasing description of a good or service” refers to a description of a good or service that is associated with a particular financial transaction. For example, the purchasing description preferably includes a classification, a brand, and a request amount for the particular good or service.

In yet another preferred embodiment, the donation option is transmitted to the payment terminal separate from the transaction instruction. As used herein, the term “donation option” refers to (1) an instruction to charge a consumer account and credit a donation amount to a beneficiary account, hereinafter referred to as a “consumer option”; (2) an instruction to charge a payment network account and credit a donation amount to a beneficiary account, hereinafter referred to as a “payment network option”; and (3) an instruction to charge a merchant account and credit a donation amount to a beneficiary account, hereinafter referred to as a “merchant option,” or any combination of the above.

Upon transmission of the transaction instruction from the payment device 12 to the payment terminal 14, the transaction module 14A of the payment terminal 14 transmits the donation option and an authorization request 74 to the financial institution 16. Preferably, the authorization request includes the purchasing description. Next, the financial institution 16 forwards the authorization request and the donation option through a conventional payment network 76 to the credit provider 20.

In one preferred embodiment, the credit provider 20 receives the authorization request and donation option. With respect to the authorization request, the control module 22A of the server 22 compares the authorization request to account information for the consumer in the datastore 78. Based upon the comparisons between the consumer account and control module 22A, the credit provider 20 can authorize or deny the authorization request 80.

For example, in one preferred embodiment, if the request amount included in the authorization request exceeds the total amount of allowable credit available in the consumer account, the control module 22A denies the transaction 80 and sends a denial message back through the payment network to the payment terminal 102.

Alternatively, in another preferred embodiment, if the request amount included in the authorization request does not exceed the total amount of allowable credit available in the consumer account, the control module 22A authorizes the transaction 80.

With respect to the donation option, the profile module 22B of server 22 compares the donation option to account information for the consumer in the datastore 78. Based upon the comparisons between the consumer account information and profile module 22B, the credit provider can process the donation option as described below.

If the control module 22A authorizes the transaction, then the profile module 22B determines if a donation option is a consumer option 82.

If the donation option is a consumer option, then the profile module 22B preferably compares a purchasing description of a good or service included in the transaction instruction to a pre-selected description of a good or service associated with the user account 84.

If the comparison of the purchasing and pre-selected descriptions are a match, then the profile module 22B preferably charges a donation account to the consumer account 86, and credits the donation amount to a beneficiary account 88.

In a preferred embodiment, if the profile module 22B determines that the donation option is a consumer option or payment network option, then a profile module 22B preferably credits the donation amount to a beneficiary account 92, without comparing a purchasing description of a good or service to a pre-selected description of a good or service. Preferably, the donation amount includes a portion of a transaction fee charged by the payment network.

In another preferred embodiment, if the profile module 22B determines that the donation option is a consumer option or payment network option, the profile module 22B preferably compares a purchasing description of a good or service to a pre-selected description of a good or service associated with the consumer account or payment network account, respectively. If the comparison of the purchasing and pre-selected descriptions are a match, then the profile module 22B preferably charges a donation account to the payment network account, and credits the donation amount to a beneficiary account.

Next, if the profile module 22B determines that the donation option is a merchant option, the profile module 22B preferably compares a purchasing description of a good or service to a pre-selected description of a good or service 96 associated with the merchant account.

If the comparison of the purchasing and pre-selected descriptions are a match, then a profile module 22B preferably credits the donation amount to a beneficiary account 98.

Alternatively, if the donation option is not a consumer option, payment network option, or a merchant option, then the profile module 22B preferably sends an authorization message back through the payment network to the payment device 100.

A number of embodiments of the invention have been described. Nevertheless, it will be understood that various modifications may be made without departing from the spirit and scope of the invention. For example, one or more profile modules can be configured to provide profile module functioning and can be configured on various servers at various financial institutions. Also, the steps described above may be modified in various ways or performed in a different order than described above, where appropriate. Accordingly, alternative embodiments are within the scope of the following claims.

What is claimed is:

1. A system for conducting multiple payment transactions comprising
a payment device capable of transmitting a financial transaction instruction for charging a consumer account a first monetary amount and a second monetary amount to be charged to said consumer account; and
a processing module for charging said first amount to said consumer account and crediting said second amount to a beneficiary account.

2. The system of claim 1, wherein said financial transaction instruction comprises a first description of a first good or service.

3. The system of claim 1, wherein said processing module provides a graphical user interface to select at least one of said beneficiary account, said second monetary amount, and a second description of a good or service.

4. The system of claim 3, wherein said processing module associates said selected beneficiary account, said second monetary amount and said second description with said consumer account.

5. The system of claim 2, wherein said processing module (a) compares said first description to a second description associated to at least one of said consumer account and a merchant account and (2) credits said second amount to said beneficiary account based on the comparison.

6. The system of claim 5, wherein said processing module compares said consumer account to said merchant account.

7. The system of claim 5, wherein said processing module charges said second amount to said merchant account.

8. The system of claim 1, wherein said processing module charges a fee for processing said financial transaction instruction and credits a portion of said fee to said beneficiary account.

9. The system of claim 1, wherein said payment device is selected from the group consisting essentially of a smart card, magnetic stripe card, PDA, and cellular phone.

10. A method for conducting multiple payment transactions comprising
transmitting a financial transaction instruction for charging a consumer account a first monetary amount and a second monetary amount to be charged to said consumer account; and
charging said first amount to said consumer account; and
crediting said second amount to a beneficiary account.

11. The method of claim 10, wherein said financial transaction instruction comprises a first description of a first good or service.

12. The method of claim 10 further comprising providing a graphical user interface to select at least one of said beneficiary account, said second monetary amount, and a second description of a good or service.

13. The method of claim 12 further comprising associating said selected beneficiary account, said second monetary amount, and said second description with said consumer account.

14. The method of claim 13 further comprising comparing said first description to a second description associated to at least one of said consumer account and a merchant account and (2) crediting said second amount to said beneficiary account based on the comparison.

15. The method of claim 14 further comprising comparing said consumer account to said merchant account.

16. The method of claim 14 further comprising charging said second amount to said merchant account.

17. The method of claim 10, further comprising charging a fee for processing said financial transaction instruction and credits a portion of said fee to said beneficiary account.
